(19) United States
(12) Patent Application Publication
(10) Pub. No.: US 2025/0252233 A1
(43) Pub. Date: Aug. 7, 2025

(54) NEURAL NETWORK-BASED METHOD FOR PREDICTING AERODYNAMIC PERFORMANCE OF COMPRESSOR OF MODELLING DESIGN AND SYSTEM THEREFOR

(71) Applicant: Harbin Engineering University, Harbin City (CN)

(72) Inventors: Chen LIU, Harbin City (CN); Zexi WU, Harbin City (CN); Yipeng CAO, Harbin City (CN); Chenqi YU, Harbin City (CN); Xu ZHAN, Harbin City (CN); Jie YANG, Harbin City (CN); Xiaochen ZHAO, Harbin City (CN)

(21) Appl. No.: 18/830,408

(22) Filed: Sep. 10, 2024

(30) Foreign Application Priority Data
Feb. 1, 2024 (CN) 202410137315.4

(51) Int. Cl. G06F 30/27; G06F 30/15; G06F 119/14

(52) U.S. Cl. CPC G06F 30/27; G06F 30/15; G06F 2119/14

(57) ABSTRACT

A neural network-based method for predicting aerodynamic performance of a compressor of modeling design and a system therefor are provided. The method includes: constructing a data set; constructing a loss function, wherein the loss function is constructed based on a similarity modeling criterion; training a momentum-optimized neural network model according to the data set and the loss function to obtain an aerodynamic performance prediction model of the compressor of modeling design; predicting an aerodynamic performance of the compressor of modeling design by using the aerodynamic performance prediction model of the compressor of modeling design. According to the method, the momentum-optimized neural network model is trained by using the constructed data set and the loss function constructed based on the similarity modeling criterion, and the deep learning technology is applied to the aerodynamic performance prediction of the compressor of modeling design.

### CROSS-REFERENCE TO RELATED APPLICATION

This patent application claims the benefit of and priority to Chinese Patent Application No. 202410137315.4, filed with the Chinese Patent Office on Feb. 1, 2024, which is hereby incorporated by reference herein in its entirety.

### TECHNICAL FIELD

The present disclosure relates to the field of aerodynamic performance prediction of a compressor, in particular to a neural network-based method for predicting aerodynamic performance of a compressor of modelling design and a system therefor.

### BACKGROUND

A compressor is a key component in aero-engines, rocket engines and other industrial fields. The main function of the compressor is to compress air to a higher pressure to satisfy the demand of subsequent components such as combustion chambers or turbines. However, since the compressor technology is complicated and some mechanisms in the complicated flow inside the compressor need to be further researched, a compressor with good performance often develops from a mature prototype.

At present, a traditional research method of aerodynamic performance of a compressor mainly relies on experiments and numerical simulation. Experimental methods usually need to construct a complicated experimental platform, which is expensive and difficult to realize real-time monitoring of the compressor under different working conditions. In numerical simulation methods, the accuracy and reliability of numerical simulation results are still limited due to the complicacy and nonlinear characteristics of the compressor.

The application of the deep learning technology is outstanding in the prediction of aerodynamic parameters of an internal flow field of a compressor. The research shows that the deep learning method can effectively perform accurate prediction on the aerodynamic parameters of the internal flow field of the compressor. The error rate of the pressure coefficient predicted by the model is less than 0.2%, and the error rate of the total pressure loss coefficient is less than 1.2%. However, at present, only the performance of compressors of a single model is predicted. For example, the aerodynamic performance of the compressors of a single model is predicted by using a feed-forward neural network with a Gaussian kernel function and by using other interpolation methods. As the performance of the compressors of a single model is only related to pressure ratio, and flow rate and rotating speed of the compressor, the change of the performance curve of compressors of a series of modelling design is not only related to the pressure ratio, the flow rate and the rotating speed. The pressure ratio, the flow rate and the rotating speed are related to many geometric structure parameters in modelling design based on similarity modelling criterion. Thus the performance prediction method for the compressors of a single model is not suitable for predicting the performance of compressors of a series of modelling design. The performance prediction of the compressor of a series of modelling design is still in the stage of numerical simulation prediction, and a method based on deep learning is urgently needed to predict the aerodynamic performance of the compressor of a series of modelling design, so as to improve the accuracy and the efficiency of the performance prediction of the compressor of modelling design.

### SUMMARY

The present disclosure aims to provide a neural network-based method for predicting aerodynamic performance of a compressor of modelling design and a system therefor. A momentum-optimized neural network model is trained by using a constructed data set and a constructed loss function, and a deep learning technology is applied to the aerodynamic performance prediction of the compressor of modelling design.

In order to achieve the above objectives, the present disclosure provides the following scheme.

In a first aspect, the present disclosure provides a neural network-based method for predicting aerodynamic performance of a compressor of modelling design, where the method includes:
constructing a data set, where the data set includes a plurality of sample data, and the sample data includes input data and corresponding label data; the sample data includes a plurality of aerodynamic performance parameters of a compressor including a modelling ratio, a pressure ratio, a flow rate and a rotating speed; the label data is the flow rate; the input data is the modelling ratio, the pressure ratio and the rotating speed; the compressor includes a prototype compressor and a sub-type compressor obtained from the prototype compressor after modelling design;
constructing a loss function, where the loss function is constructed based on a similarity modelling criterion;
training a momentum-optimized neural network model according to the data set and the loss function to obtain an aerodynamic performance prediction model of a compressor of modelling design;
predicting an aerodynamic performance of the compressor of modelling design by using the aerodynamic performance prediction model of the compressor of modelling design, where the compressor of modelling design is a sub-type compressor obtained based on the prototype compressor after modelling design.

In an embodiment, the loss function is:

$$J ( θ ) = \{ \begin{matrix}\frac{{\sum }_{i = 1}^{n} \sqrt{{α ( vt - f ( x ) )}^{2} + {β ( et - f ( x ) )}^{2}}}{n} , vt \neq et \\ \frac{{\sum }_{i = 1}^{n} \sqrt{{( et - f ( x ) )}^{2}}}{n} , vt = et\end{matrix} ; \\ α = \frac{‖ ( vt - f ( x ) ) ‖ ‖ et - f ( x ) ‖}{‖ vt - et ‖} ; \\ α = 1 - β ;$$

where J(θ) is the loss function; vt=M²Q₀, where M denotes a modelling ratio of the sub-type compressor, Q₀ denotes a flow rate of the prototype compressor; α and β are weighting factors; et denotes a flow rate of the sub-type compressor; f(x) is a predicted flow rate output by the neural network model; n denotes the number of labels.

For the aerodynamic performance parameters in a performance curve of the compressor, obtaining the modelling ratio, the pressure ratio, the flow rate and the rotating speed in a manner of acquiring ten data points per rotating speed line and from fourteen rotating speed lines, and constructing the data set according to the modelling ratio, the pressure ratio, the flow rate and the rotating speed acquired.

In an embodiment, in process of training the momentum-optimized neural network model, following algorithm is used to optimize a weight of the momentum-optimized neural network model:

$${W}^{′} = W + m ; \\ m = β m - η {∇}_{w} J ( θ ) ;$$

where m is a momentum vector, η is a learning rate, ∇_{w} is a differential operator, J(θ) is the loss function, W is a weight prior to optimization, W′ is a weight subsequent to optimization, and β is a hyper-parameter.

In an embodiment, prior to the training a momentum-optimized neural network model according to the data set and the loss function, the method includes:
carrying out reversible instance normalization on the data set to obtain a data set after reversible instance normalization;
where the data set after reversible instance normalization is used to train the momentum-optimized neural network model.

In an embodiment, calculation equation for carrying out reversible instance normalization on the data set is:

$${x}^{*} = \frac{x - μ}{σ} ;$$

where x is the data set, μ is an average value of all sample data in the data set, σ is a standard deviation of all sample data in the data set, and x* is the data set after reversible instance normalization.

In an embodiment, the momentum-optimized neural network model includes an input layer, a hidden layer and an output layer; the input layer includes three neurons; the hidden layer is a two-layer structure, and each layer includes 36 neurons; and the output layer includes one neuron.

In an embodiment, training the momentum-optimized neural network model includes:
optimize a hyper-parameter of the momentum-optimized neural network model by using a grid search method.

In a second aspect, the present disclosure further provides a neural network-based system for predicting aerodynamic performance of a compressor of modelling design, including:
a data set constructing module, configured to construct a data set, where the data set includes a plurality of sample data, and the sample data includes input data and corresponding label data; the sample data includes a plurality of aerodynamic performance parameters of a compressor including a modelling ratio, a pressure ratio, a flow rate and a rotating speed; the label data is the flow rate; the input data is the modelling ratio, the pressure ratio and the rotating speed; the compressor includes a prototype compressor and a sub-type compressor obtained from the prototype compressor after modelling design;
a loss function constructing module, configured to construct a loss function, where the loss function is constructed based on a similarity modelling criterion;
a model training module, configured to train a momentum-optimized neural network model according to the data set and the loss function to obtain an aerodynamic performance prediction model of a compressor of modelling design;
an aerodynamic performance predicting module, configured to predict an aerodynamic performance of the compressor of modelling design by using the aerodynamic performance prediction model of the compressor of modelling design, where the compressor of modelling design is a sub-type compressor obtained based on the prototype compressor after modelling design.

According to the specific embodiment provided by the present disclosure, the present disclosure provides the following technical effects.

The present disclosure provides a neural network-based method for predicting aerodynamic performance of a compressor of modelling design and a system therefor. At present, traditional methods of experiments and numerical simulation are used to research the aerodynamic performance of the compressor, which have problems that a complicated experimental platform needs to be constructed, which is expensive and difficult to realize real-time monitoring of the compressor under different working conditions. In numerical simulation methods, the accuracy and reliability of numerical simulation results are still limited due to the complexity and nonlinear characteristics of the compressor. And the prediction method of the performance curve for the compressors of a single model is not suitable for predicting performance of compressors of a series of modelling design. According to the present disclosure, the momentum-optimized neural network model is trained by using the constructed data set and the loss function constructed based on the similarity modelling criterion, and the deep learning technology is applied to the aerodynamic performance prediction of the compressor of modelling design, which can make full use of the advantages of the deep learning technology, thereby improving effectively the accuracy and the efficiency of the aerodynamic performance prediction of the compressor of modelling design.

### BRIEF DESCRIPTION OF THE DRAWINGS

In order to explain the embodiments of the present disclosure or the technical schemes in the prior art more clearly, the drawings that need to be used in the embodiments will be briefly introduced. Obviously, the drawings in the following description are only some embodiments of the present disclosure. For those skilled in the art, other drawings can be obtained according to these drawings without creative labor.

FIG. 1 is a flow chart of a neural network-based method for predicting aerodynamic performance of a compressor of modelling design according to an embodiment of the present disclosure.

FIG. 2 is a schematic diagram of a relationship between a loss function and a neural network according to an embodiment of the present disclosure.

FIG. 3 is a schematic diagram of a sample space diagram of a loss function according to an embodiment of the present disclosure.

FIG. 4 is a structural diagram of a momentum-optimized neural network model according to an embodiment of the present disclosure.

FIG. 5 is a schematic diagram of a relationship between input and output of an ELU activation function according to an embodiment of the present disclosure.

FIG. 6 is a flowchart of another neural network-based method of predicting aerodynamic performance of a compressor of modelling design according to an embodiment of the present disclosure.

FIG. 7 is a schematic diagram of a neural network-based system of predicting aerodynamic performance of a compressor of modelling design according to an embodiment of the present disclosure.

### DETAILED DESCRIPTION OF THE EMBODIMENTS

The technical schemes in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments obtained by those skilled in the art without creative labor fall within the scope of protection of the present disclosure.

### Explanation of Terms

Deep learning: deep learning is a sub-field of machine learning, which mainly studies algorithms and models used to simulate the human learning and thinking process. This usually involves the use of a neural network with a plurality of hidden layers for automatically extracting advanced features from raw data.

Neural network: the neural network is a calculation model that simulates the working mechanism of a human brain and is used to identify patterns or classify and predict data. The neural network consists of an input layer, one or more hidden layers and an output layer, and each layer is provided with a plurality of nodes (or “neurons”).

Modelling design: modelling design is an engineering practice, which creates a model or prototype by reducing or enlarging the actual physical system. The model follows the same physical rules and equations as the actual system, so as to predict the behavior of the actual system at different scales or conditions.

Optimization algorithm: an optimization algorithm is a mathematical method used to find the optimal (or “optimized”) solution, which is usually achieved by maximizing or minimizing an objective function. This is widely used in many fields such as machine learning and engineering design.

Activation function: an activation function is a function used to convert input signals between neural network layers into output signals. The commonly used activation functions include Rectified Linear Unit (RELU), Sigmoid and Tan h, etc.

Loss function: a loss function is a measure of quantifying difference between the model prediction and the actual result. In supervised learning, the loss function is used to adjust the model parameters in the training process to minimize the prediction error.

Hyper-parameter optimization: hyper-parameter optimization is a process of adjusting a hyper-parameter (such as the learning rate, the regularization coefficient, etc.) of the model in machine learning and statistical modelling to improve the model performance. This is usually done by the methods such as grid search, random search or Bayesian optimization.

A compressor is a key component in aero-engines, rocket engines and other industrial fields. The main function of the compressor is to compress air to a higher pressure to satisfy the demand of subsequent components such as combustion chambers or turbines. However, since the compressor technology is complicated and some mechanisms in the complicated flow inside the compressor need to be further researched, a compressor with good performance often develops from a mature prototype.

A traditional research method of aerodynamic performance of a compressor mainly relies on experiments and numerical simulation. Experimental methods usually need to construct a complicated experimental platform, which is expensive and difficult to realize real-time monitoring of the compressor under different working conditions. In numerical simulation methods, the accuracy and reliability of numerical simulation results are still limited due to the complicacy and nonlinear characteristics of the compressor.

The existing implementation scheme closest to the present disclosure only predicts the performance of compressors of a single model. For example, the aerodynamic performance of the compressors of a single model is predicted by using a feed-forward neural network with a Gaussian kernel function and by using other interpolation methods. However, the neural network for predicting the compressors of a single model extracts characteristics of the performance curves of multiple models of compressors of modelling design poorly. The prediction at performance curves of different compressors with overlapping working conditions will be confused, which causes prediction errors. Neural network that predict only the compressors of a single model cannot achieve an expected accurate results when being used to predict the compressor of modelling design. At present, the performance prediction of the compressor of modelling design is still in the stage of numerical simulation prediction.

Therefore, in view of the above shortcomings, the present disclosure provides a neural network-based method for predicting aerodynamic performance of a compressor of modelling design, which mainly uses technologies such as deep learning and machine learning. Specifically, these methods predict the aerodynamic performance of the compressor by collecting the experiment data of a limited number of compressors, and using these data to train the neural network model. These methods can not only improve the prediction accuracy and shorten the design cycle, but also reduce the design cost, which is of great significance to improve the design and performance of the compressor. Unlike the performance curve prediction of the compressors of a single model, the performance of the compressors of a single model is only related to the pressure ratio, and the flow rate and the rotating speed of the compressor. The change of the performance curve of compressors of a series of modelling design is related to the pressure ratio, the flow rate and the rotating speed, and the pressure ratio, the flow rate and the rotating speed are related to many geometric structure parameters in the modelling design based on the similarity modelling criterion. Therefore, the change of the performance of the compressor of modelling design is a high-dimensional nonlinear problem influenced by multi-dimensional factors. In order to save computation resources for performance prediction of modelling design, the present disclosure simplifies such a high-dimensional nonlinear problem, proposes a new neural network loss function based on the modelling criterion to reduce dimensions of factors influencing performance of the compressor, and simplifies such a complex high-dimensional nonlinear problem to the same difficulty as a prediction problem of the performance curve of the compressors of a single model.

The purpose of the present disclosure is to provide a neural network-based method for predicting aerodynamic performance of a compressor of modelling design and a system therefor.

In order to make the above objects, features and advantages of the present disclosure more obvious and understandable, the present disclosure will be explained in further detail with reference to the drawings and detailed description hereinafter.

### Embodiment 1

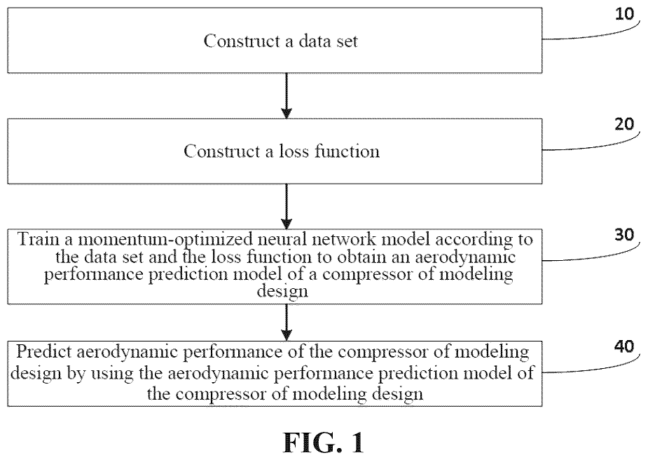

As shown in FIG. 1, the present disclosure provides a neural network-based method for predicting aerodynamic performance of a compressor of modeling design, where the method includes:
Step 10: A data set is constructed, where the data set includes a plurality of sample data, and the sample data includes input data and corresponding label data. The sample data includes a plurality of aerodynamic performance parameters of a compressor including a modeling ratio, a pressure ratio, a flow rate and a rotating speed; the label data is the flow rate. The input data is the modeling ratio, the pressure ratio and the rotating speed; the compressor includes a prototype compressor and a sub-type compressor obtained from the prototype compressor after modeling design;
Step 20: A loss function is constructed, where the loss function is constructed based on a similarity modeling criterion;
Step 30: A momentum-optimized neural network model is trained according to the data set and the loss function to obtain an aerodynamic performance prediction model of a compressor of modeling design;
Step 40: The aerodynamic performance of the compressor of modeling design is predicted by using the aerodynamic performance prediction model of the compressor of modeling design, where the compressor of modeling design is a sub-type compressor obtained based on the prototype compressor after modeling design.

In some embodiments, the loss function is:

$$J ( θ ) = \{ \begin{matrix}\frac{{\sum }_{i = 1}^{n} \sqrt{{α ( vt - f ( x ) )}^{2} + {β ( et - f ( x ) )}^{2}}}{n} , vt \neq et \\ \frac{{\sum }_{i = 1}^{n} \sqrt{{( et - f ( x ) )}^{2}}}{n} , vt = et\end{matrix} ; \\ α = \frac{‖ ( vt - f ( x ) ) ‖ ‖ et - f ( x ) ‖}{‖ vt - et ‖} ; \\ α = 1 - β ;$$

where J(θ) is the loss function, and the smaller the value of the function, the stronger the performance of the neural network model; vt is a theoretical value obtained based on a criterion of modeling design, vt=M²Q₀, where M denotes a modeling ratio of the sub-type compressor, Q₀ denotes a flow rate of the prototype compressor; α and β are weighting factors; et denotes a flow rate of the sub-type compressor, that is, the target value in the data set, and also an experimental value of modeling design; f(x) is a predicted flow rate output by the neural network model; n denotes the number of labels.

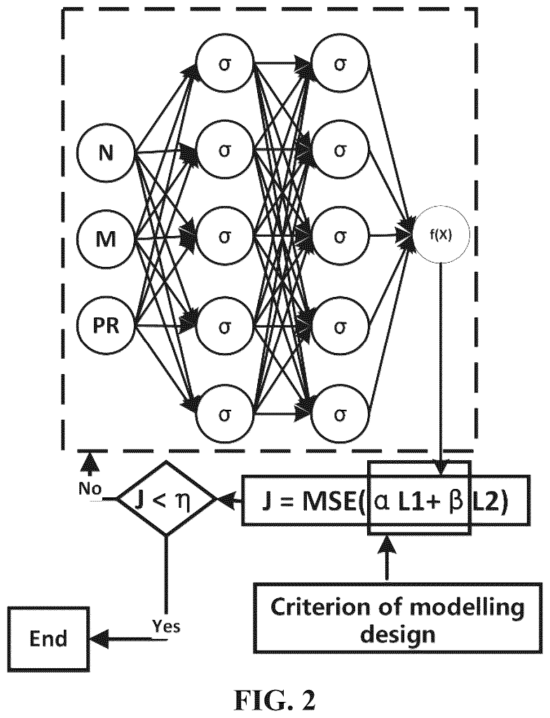

The above loss function is proposed for the first time in the present disclosure and can be applied to any rotating machinery with a similar relationship. The loss function is a loss function embedded with model information. Unlike the traditional loss function, the defined weight factor of the above loss function is updated in real time with the change of the output of the neural network model, but tends to decrease overall, which can accelerate the convergence of the neural network. The relationship between the loss function and the neural network is shown in FIG. 2, where n denotes an expected error, n denotes a rotating speed, M denotes a modeling ratio, and PR denotes a pressure ratio.

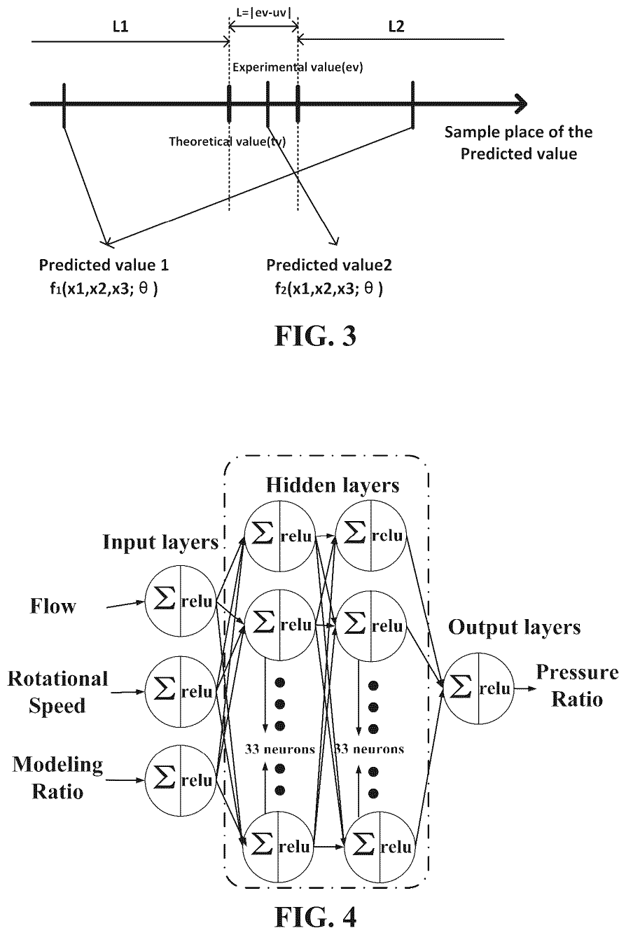

The purpose of the loss function is to accelerate the predicted value to approach the experimental value. After introducing a theoretical value of the similarity modeling criterion model, the neural network can quickly learn and fit the similarity modeling criterion model embedded in the loss function. As we all know, the predicted value is generated randomly before being constrained and optimized, and the difference between the theoretical value and the experimental value is very small. When the predicted value falls outside the sample space of the theoretical value and the experimental value, it is assumed that the predicted value is far from the experimental value by default. At this time, a weight factor α of L1 is larger, and the loss function will pay more attention to making L1 smaller in the optimization process, that is, the predicted value is close to the theoretical value. When L1 becomes smaller, the predicted value falls inside the sample space of the theoretical value and the experimental value. At this time, a weight factor β will be larger, which makes the loss function closer to the experimental value in optimization process until loss decays to the set expected error. It is noteworthy that the set expected error is less than difference between the theoretical value and the experimental value. The relationship of the sample space diagram of the loss function is shown in FIG. 3, where L, L1 and L2 only denote the length; f1 and f2 are predicted values of different batches.

In some embodiments, Step 10 specifically includes:

For the aerodynamic performance parameters in a performance curve of the compressor, data points are acquired in a manner of acquiring ten data points per each rotating speed line and from fourteen rotating speed lines, to obtain the modelling ratio, the pressure ratio, the flow rate and the rotating speed, and the data set is constructed according to the modeling ratio, the pressure ratio, the flow rate and the rotating speed acquired.

In some embodiments, in process of establishing an Artificial Neural Network (ANN), a feed-forward neural network framework is used, where calculation equation for data calculation among various layers is:

$$f ( x ) = X @ W + b ;$$

where @ denotes an inner product operation of the neural network; f(x) denotes a predicted value of the neural network model; X denotes a training set; W denotes a weight of each neural layer of the neural network model; b denotes a bias of each neural layer of the neural network model.

In some embodiments, Step 30 includes:

In order to optimize weight and bias among layers, this embodiment uses the following algorithm to optimize weight of the momentum-optimized neural network model:

$${W}^{′} = W + m ; \\ m = β m - η {∇}_{w} J ( θ ) ;$$

where m is a momentum vector, η is a learning rate, ∇_{w} is a differential operator, J(θ) is a loss function, W is a weight prior to optimization, W′ is a weight subsequent to optimization, and β is a hyper-parameter.

A traditional gradient descent algorithm updates the weight W by directly subtracting a product of the gradient of the loss function J(θ) and the learning rate η from the weight, which is calculated as follow:

$$W = W - η ∇ J ( θ ) .$$

The traditional gradient descent algorithm does not care about the early gradient, but the gradient descent algorithm based on momentum optimization cares about the early gradient. In each iteration, it fades the local gradient from the momentum vector m (multiplied by the learning rate η), and updates the weight by adding a momentum vector. In order to simulate friction mechanism and prevent an excessive momentum, the gradient descent algorithm based on momentum optimization introduces a new hyper-parameter β, called momentum, which is set between 0 (high friction) and 1 (no friction). In this embodiment, the hyper-parameter β of the ANN is set to 0.9.

In some embodiments, prior to Step 30, the method includes:
reversible instance normalization is carried out on the data set to obtain a data set after reversible instance normalization;
where the data set after reversible instance normalization is used to train the momentum-optimized neural network model.

In some embodiments, the calculation equation of carrying out reversible instance normalization on the data set is:

$${x}^{*} = \frac{x - μ}{σ} ;$$

where x is the data set, μ is an average value of all sample data in the data set, σ is a standard deviation of all sample data in the data set, and x* is the data set after reversible instance normalization.

In some embodiments, Step 30 includes:

A grid search method is used to optimize the hyper-parameter of the momentum-optimized neural network model.

In some embodiments, the process of using a grid search method to optimize the hyper-parameter of the momentum-optimized neural network model includes the following steps.
1. Defining the search space: a network structure and a hyper-parameters that need to be optimized are determined, such as the number of hidden layers; the number of neurons in each hidden layer; an activation function (ELU).
2. Generating a grid: a set of values is created for each hyper-parameter, and then the Cartesian products of hyper-parameters are generated to form a grid.
3. Training a model: for a combination of each group of hyper-parameters in the grid, a new neural network with a selected structure and parameters is created; the training data is used to train the model; the validation set is used to evaluate the performance of the model.
4. Evaluating performance: indexes such as cross-validation accuracy, balanced scores (F1 scores) and area under curve-receiver operating characteristic curve (AUC-ROC curves) are used to evaluate the model performance.
5. Recording the results: each group of parameters and their corresponding performance indexes are saved.
6. Selecting an optimal model: the model that performs best is selected according to performance index.
7. Verification and testing: an independent testing set is used to further verify the generalization ability of the selected model.

As shown in FIG. 4, in some embodiments, the momentum-optimized neural network model includes the input layer, the hidden layers and the output layer; the input layer includes three neurons; the hidden layer is a two-layer structure, and each layer includes 36 neurons; and the output layer includes one neuron.

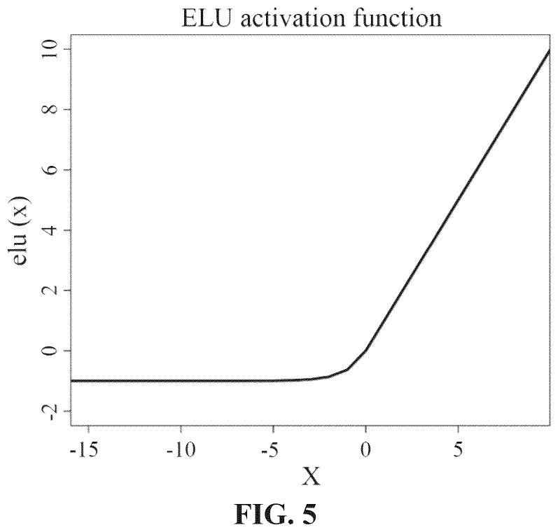

As shown in FIG. 5, in some embodiments, the activation function is an exponential linear unit (ELU) activation function expressed as follow:

$$E L U ( x ) = \{ \begin{matrix}{e}^{x} - 1 \\ x\end{matrix} ;$$

where x denotes an output of the previous layer of neurons.

In some embodiments, the neural network-based method for predicting aerodynamic performance of the compressor of modeling design may also be as follows.

A performance curve of the sub-type compressor is obtained by modeling the prototype compressor. A data set concerning the four performance parameters (the modeling ratio, the pressure ratio, the flow rate and the rotating speed) in the performance curve of the sub-type compressor and the performance curve of the prototype compressor is constructed in a manner of acquiring ten data points per rotating speed line and from fourteen rotating speed lines. 80% of the data set is used as a training set, 10% of the data set is used as a testing set, and 10% of the data set is used as a verification set; and then the momentum-optimized ANN is constructed; the ANN is trained by optimizing a network connection weight and optimizing a network hyper-parameter, so as to obtain a reliable momentum-optimized ANN. Finally, the performance parameters of modeling design are output. Through the above process, the aerodynamic performance of the compressor can be predicted.

The data set includes data of the prototype compressor and a few sub-type compressors, that is, the modeling ratio, the pressure ratio, the rotating speed and the flow rate, where the modeling ratio of the prototype compressor is 1.

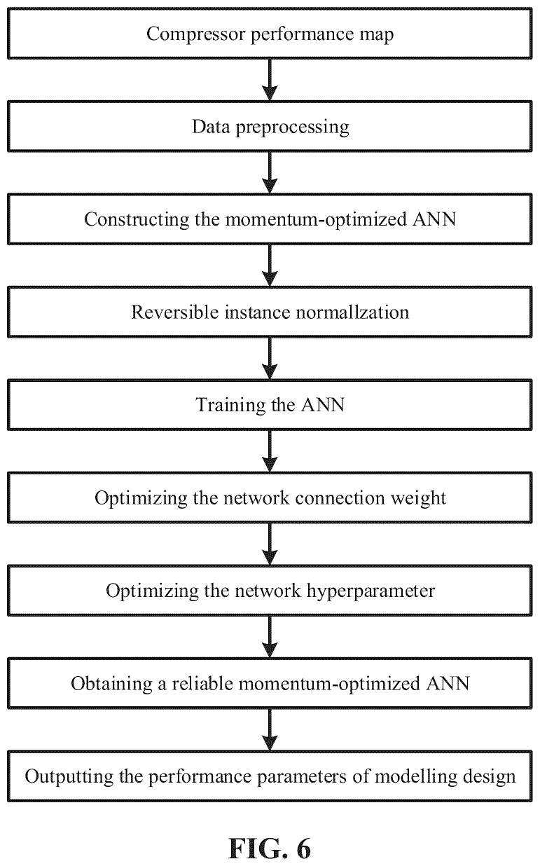

As shown in FIG. 6, in some embodiments, the neural network-based method for predicting aerodynamic performance of the compressor of modeling design may also be as follows.

Step 100: the performance curve of the sub-type compressor is obtained by modeling the prototype compressor. Prior to constructing the data set, a model of a reference compressor is selected. The reference compressor is a prototype compressor. The flow rate of the reference compressor is applied to the loss function. The data set concerning the four performance parameters (the modeling ratio, the pressure ratio, the flow rate and the rotating speed) in the performance curve of the compressors of each model is constructed in a manner of acquiring ten data points per rotating speed line and from fourteen rotating speed lines. The modeling ratio, the pressure ratio and the rotating speed are used as input, and the flow rate is used as output.

Step 200: 80% of the data set is used as the training set, 10% of the data set is used as the testing set, and 10% of the data set as the verification set.

Step 300: the momentum-optimized artificial neural network (ANN) is constructed.

Step 400: a reversible instance is normalized.

Step 500: the loss function based on the similarity modeling criterion is constructed.

Step 600: the ANN is trained by optimizing the network connection weight and optimizing the network hyper-parameter, so as to obtain a reliable momentum-optimized ANN.

Optimization algorithms for the weight and the bias are not limited to gradient descent method based on momentum optimization, and further include a Newton method, a quasi-Newton method, an adaptive moment estimation and so on.

Hyper-parameter optimization methods are not limited to grid search, and further include: random searching parameter, Bayesian optimization, a multi-objective genetic algorithm, a particle swarm optimization algorithm, a simulated annealing algorithm, a multi-objective particle swarm optimization algorithm, a dominant sorting genetic algorithm and so on.

Step 700: finally, the performance parameters of modeling design are output.

In some embodiments, the ANN model includes Convolutional Neural Network (CNN), Recurrent Neural Network (RNN), Gated Recurrent Unit (GRU), Long Short-Term Memory (LSTM), Bidirectional Encoder Representations from Transformers (BERT), Transformer and one or more of common variants of the deep learning neural networks, and the main structure is a fully connected neural network.

In some embodiments, Step 300 specifically includes the following steps.

Step 301: dimensions of the training data are divided according to extracted features. Each feature is regarded as an input dimension. If the input dimension is 3, the number of neurons in the input layer is 3. That is, if there are three inputs, the number of neurons in the input layer is three.

Step 302: the number of hidden layers of the neural network and the number of neurons in each layer are initialized.

Step 303: it is determined that the output is one-dimensional, and there is a neuron in the output layer, and it is ensured that the error of the network can be propagated back. That is, if there is an output, the number of neurons in the output layer is one.

Step 304: The error to be propagated back is calculated by the loss function based on the similarity modeling criterion.

In some embodiments, Step 600 specifically includes the following steps.

Step 601: the weight and the bias are initialized.

Step 602: the momentum-optimized gradient descent method is applied to optimize the weight (optimization algorithm is not unique).

Step 603: the grid search method is applied to optimize the hyper-parameter (method for optimizing network hyper-parameter is not unique).

Step 604: obtained reliable hyper-parameter is reassigned.

Step 605: a reliable neural network is obtained.

### Embodiment 2

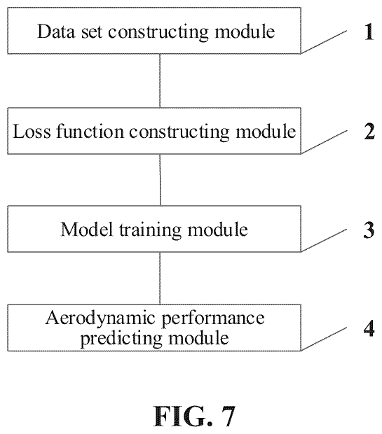

As shown in FIG. 7, this embodiment provides a neural network-based system for predicting aerodynamic performance of a compressor of modeling design, including:
a data set constructing module, configured to construct a data set, where the data set includes a plurality of sample data, and the sample data includes input data and corresponding label data; the sample data includes a plurality of aerodynamic performance parameters of a compressor including a modeling ratio, a pressure ratio, a flow rate and a rotating speed; the label data is the flow rate; the input data is the modeling ratio, the pressure ratio and the rotating speed; the compressor includes a prototype compressor and a sub-type compressor obtained from the prototype compressor after modeling design;
a loss function constructing module, configured to construct a loss function, where the loss function is constructed based on a similarity modeling criterion;
a model training module, configured to train a momentum-optimized neural network model according to the data set and the loss function to obtain an aerodynamic performance prediction model of a compressor of modeling design;
an aerodynamic performance predicting module, configured to predict an aerodynamic performance of the compressor of modeling design by using the aerodynamic performance prediction model of the compressor of modeling design, where the compressor of modeling design is a sub-type compressor obtained based on the prototype compressor after modeling design.

To sum up, the present disclosure has the following advantages.
(1) The present disclosure provides a neural network-based method for predicting aerodynamic performance of a compressor of modeling design, which collects the experimental data of a limited series of compressors of modeling design, and then uses these data to train the neural network model, so as to predict the aerodynamic performance of the compressor of modeling design. The method can not only improve the prediction accuracy and shorten the design cycle, but also reduce the design cost, which is of great significance to improve the design and performance of the compressor. The method solves problems that it is complicated and expensive to construct the experimental platform due to traditional experiments and numerical simulation, and problems that it is difficult to realize real-time monitoring of the compressor under different working conditions and that the accuracy and reliability of numerical simulation results are limited due to complicacy and nonlinear characteristics of the compressor.
(2) The neural network has shown a plurality of remarkable advantages in performance prediction of the compressor, which solve the shortcomings and limitations of traditional simulation and prediction methods to a large extent. Firstly, the neural network has excellent data-driven and adaptive ability. Unlike the traditional physical model, which needs to define a series of complex parameters manually, the neural network can automatically learn and adapt from a large number of experimental and numerical simulation data. This self-adaptability enables the neural network model to accurately capture the key characteristics of performance of the compressor without tedious manual adjustment. Secondly, the neural network also has obvious advantages in dealing with highly nonlinear and complex models. The traditional methods are usually based on simplified or linear physical models, which may not accurately describe the complicacy of the actual compressor system. In contrast, the neural network can capture highly nonlinear and complex interrelation, which is very common and necessary in performance prediction of the compressor. The neural network also performs well in real-time prediction and optimization. Once training is completed, the neural network model can carry out prediction quickly, which makes the network very suitable for real-time performance optimization and control. In contrast, the traditional simulation methods, such as Computational Fluid Dynamics (CFD), usually require longer calculation time, so it may not be suitable for real-time application. The neural network is also high in flexibility and versatility. Once the training is completed, this model can be easily extended or adapted to different types or sizes of compressors or compressors in different working conditions. This is in sharp contrast to traditional methods, the traditional methods may need to reconstruct or adjust the model for each specific application or working condition. In addition, the neural network can integrate multi-physical fields and multi-scale information because the neural network model can obtain and integrate information from a plurality of physical fields (such as thermodynamics and fluid mechanics) and different scales (such as a molecular level, a component level and a system level). Compared with the traditional physical model, which can only deal with a single physical field or scale, the neural network model has obvious advantages. Finally, from the perspective of reducing the simulation cost, the neural network also has its advantages. Once the training is completed, the cost of prediction by using neural network is relatively low. However, traditional numerical simulation methods, such as CFD, usually require a lot of calculation resources, which increases the simulation cost.

Moreover, the new loss function proposed by the present disclosure embeds the model information into the weight factor, so that the optimization process can change attention to the loss term with greater weight at any time anywhere, thereby accelerating the prediction convergence speed. Moreover, after the criterion of modeling design embedded in the loss function, the prediction accuracy is further improved, and the calculation resources are extremely effectively saved.
(3) The neural network-based method for predicting aerodynamic performance of the compressor of modeling design according to the present disclosure can not only perform prediction on compressors with specific models, but also predict any compressor model which has a modeling relationship and has determined parameters characterizing the modelling relationship. In addition, the method different from the prediction method of the compressors of a single model is that the whole performance curve map is predicted for the compressor of modeling design, while the prediction method of the compressors of a single model only predicts a rotating speed line.

In this specification, various embodiments are described in a progressive way. The differences between each embodiment and other embodiments are highlighted, and the same and similar parts of various embodiments can be referred to each other. Since the system provided in the embodiment corresponds to the method provided in the embodiment, the system is described simply. Refer to the description of the method for the relevant points.

In the present disclosure, specific examples are applied to illustrate the principle and implementation of the present disclosure, and the explanations of the above embodiments are only used to help understand the method and core ideas of the present disclosure. At the same time, according to the idea of the present disclosure, there will be some changes in the specific implementation and application scope for those skilled in the art. To sum up, the contents of the specification should not be construed as limiting the present disclosure.

1.-9. (canceled)

10. A neural network-based method for predicting aerodynamic performance of a compressor of modeling design, comprising:
establishing an aerodynamic performance prediction device comprising a processor and a memory having an aerodynamic performance prediction model stored therein, wherein the aerodynamic performance prediction model is obtained by:
constructing a data set, wherein the data set comprises a plurality of sample data, and the sample data comprises input data and corresponding label data; the sample data comprises a plurality of aerodynamic performance parameters of a compressor comprising a modeling ratio, a pressure ratio, a flow rate and a rotating speed; the label data is the flow rate; the input data is the modeling ratio, the pressure ratio and the rotating speed; the compressor comprises a prototype compressor and a sub-type compressor obtained from the prototype compressor after modeling design;
constructing a loss function, wherein the loss function is constructed based on a similarity modeling criterion;
training a momentum-optimized neural network model comprising an input layer, a hidden layer, and an output layer, according to the data set and the loss function, to obtain the aerodynamic performance prediction model,
wherein the loss function is:
$$J ( θ ) = \{ \begin{matrix}\frac{{\sum }_{i = 1}^{n} \sqrt{{α ( vt - f ( x ) )}^{2} + {β ( et - f ( x ) )}^{2}}}{n} , vt \neq et \\ \frac{{\sum }_{i = 1}^{n} \sqrt{{( et - f ( x ) )}^{2}}}{n} , vt = et\end{matrix} ; \\ α = \frac{‖ ( vt - f ( x ) ) ‖ ‖ et - f ( x ) ‖}{‖ vt - et ‖} ; \\ α = 1 - β ;$$
wherein J(θ) is the loss function; vt=M²Q₀, where M denotes a modeling ratio of the sub-type compressor, Q₀ denotes a flow rate of the prototype compressor; α and β are weighting factors; et denotes a flow rate of the sub-type compressor; f(x) is a predicted flow rate output by the neural network model, and n denotes a number of labels; and
inputting a predetermined modeling ratio, a pressure ratio and a rotating speed of a target compressor of modeling design into the aerodynamic performance prediction device, to obtain a flow rate of the target compressor of modeling design, wherein the target compressor of modeling design is a sub-type compressor obtained based on a known prototype compressor after modeling design, the pressure ratio and the rotating speed of the target compressor of modeling design are obtained based on the predetermined modeling ratio, a pressure ratio and rotating speed of the known prototype compressor, by using similarity principle between the sub-type compressor and the known prototype compressor.

11. The method according to claim 10, constructing a data set comprises:
for the aerodynamic performance parameters in a performance curve of the compressor, obtaining the modelling ratio, the pressure ratio, the flow rate and the rotating speed in a manner of acquiring ten data points per rotating speed line and from fourteen rotating speed lines, and constructing the data set according to the modeling ratio, the pressure ratio, the flow rate and the rotating speed acquired.

12. The method according to claim 10, wherein in process of training the momentum-optimized neural network model, following algorithm is used to optimize a weight of the momentum-optimized neural network model:
$${W}^{′} = W + m ; \\ m = β m - η {∇}_{w} J ( θ ) ;$$
wherein m is a momentum vector, η is a learning rate, ∇_{w} is a differential operator, J(θ) is the loss function, W is a weight prior to optimization, W′ is a weight subsequent to optimization, and β is a hyper-parameter.

13. The method according to claim 10, wherein prior to the training a momentum-optimized neural network model according to the data set and the loss function, the method comprises:
carrying out reversible instance normalization on the data set to obtain a data set after reversible instance normalization;
wherein the data set after reversible instance normalization is used to train the momentum-optimized neural network model.

14. The method according to claim 13, wherein calculation equation for carrying out reversible instance normalization on the data set is:
$${x}^{*} = \frac{x - μ}{σ} ;$$
where x is the data set, μ is an average value of all sample data in the data set, σ is a standard deviation of all sample data in the data set, and x* is the data set after reversible instance normalization.

15. The method according to claim 10, wherein the input layer comprises three neurons; the hidden layer is a two-layer structure, and each layer comprises 36 neurons; and the output layer comprises one neuron.

16. The method according to claim 10, wherein training the momentum-optimized neural network model comprises:
optimizing a hyper-parameter of the momentum-optimized neural network model by using a grid search method.

17. A neural network-based system for predicting aerodynamic performance of a compressor of modeling design, comprising:
an aerodynamic performance prediction device, comprising a processor and a memory having an aerodynamic performance prediction model stored therein, wherein the aerodynamic performance prediction model is obtained by:
constructing a data set, wherein the data set comprises a plurality of sample data, and the sample data comprises input data and corresponding label data; the sample data comprises a plurality of aerodynamic performance parameters of a compressor including a modeling ratio, a pressure ratio, a flow rate and a rotating speed; the label data is the flow rate; the input data is the modeling ratio, the pressure ratio and the rotating speed; the compressor comprises a prototype compressor and a sub-type compressor obtained from the prototype compressor after modeling design;
constructing a loss function, wherein the loss function is constructed based on a similarity modeling criterion;
training a momentum-optimized neural network model comprising an input layer, a hidden layer and an output layer, according to the data set and the loss function to obtain the aerodynamic performance prediction model, wherein the loss function is:
$$J ( θ ) = \{ \begin{matrix}\frac{{\sum }_{i = 1}^{n} \sqrt{{α ( vt - f ( x ) )}^{2} + {β ( et - f ( x ) )}^{2}}}{n} , vt \neq et \\ \frac{{\sum }_{i = 1}^{n} \sqrt{{( et - f ( x ) )}^{2}}}{n} , vt = et\end{matrix} ; \\ α = \frac{‖ ( vt - f ( x ) ) ‖ ‖ et - f ( x ) ‖}{‖ vt - et ‖} ; \\ α = 1 - β ;$$
wherein J(θ) is the loss function; vt=M²Q₀, where M denotes a modeling ratio of the sub-type compressor, Q₀ denotes a flow rate of the prototype compressor; α and β are weighting factors; et denotes a flow rate of the sub-type compressor; f(x) is a predicted flow rate output by the neural network model, and n denotes a number of labels;
the aerodynamic performance prediction device being configured for receiving a predetermined modeling ratio, a pressure ratio and a rotating speed of a target compressor of modeling design and outputting a flow rate of the target compressor of modeling design, wherein the target compressor of modeling design is a sub-type compressor obtained based on a known prototype compressor after modeling design, the pressure ratio and the rotating speed of the target compressor of modeling design are obtained based on the predetermined modeling ratio, a pressure ratio and rotating speed of the known prototype compressor, by using similarity principle between the sub-type compressor and the known prototype compressor.

18. The method according to claim 1, wherein the pressure ratio of the target compressor of modeling design is equal to a pressure ratio of the known prototype compressor, and the rotating speed of the target compressor of modeling design is obtained based on a rotating speed of the known prototype compressor and the predetermined modeling ratio by using the similarity principle between the sub-type compressor and the known prototype compressor.
